(19) United States
(12) Patent Application Publication
(10) Pub. No.: US 2009/0160178 A1
(43) Pub. Date: Jun. 25, 2009

(54) CENTERING SYSTEM FOR COUPLING FOR IRRIGATION SYSTEM

(76) Inventors: Kent C. Ericksen, Centerville, UT (US); Scot Hoskisson, Layton, UT (US)

Correspondence Address: MADSON IP, Old Shepard Commons, Suite 230, 1466 North Highway 89, Farmington, UT, 84025, US

(21) Appl. No.: 12/263,567

(22) Filed: Nov. 3, 2008

Related U.S. Application Data
(63) Continuation-in-part of application No. 11/124,217, filed on May 6, 2005, now Pat. No. 7,445,247.
Application No. 11/124,217 is a continuation of application No. 10/678,013, filed on Oct. 2, 2003, now Pat. No. 7,021,672.
(60) Provisional application No. 60/474,040, filed on May 29, 2003.

(51) Int. Cl. F16L 55/00

(52) U.S. Cl. 285/24

(57) ABSTRACT

A coupling for conveying fluid between a component of a fluid system and an insertion end of a conduit includes a coupling body with an internal bore. The insertion end of the conduit is introduced into a receiving end of said bore. A conduit centering structure is rigidly attached to the coupling body in axial alignment with the axis of the receiving end of the bore. A gripping mechanism fixes the position of the insertion end of the conduit in the receiving end of the bore, and a release mechanism slidable relative to the coupling body into a disengaging position induces the gripping mechanism to release the insertion end of the conduit. The conduit centering structure is a conduit guide or a conduit sleeve that projects from the coupling body within and in axial alignment with the receiving end of the bore. The first end of the guide sleeve is secured to the coupling body interior of the bore; the second end is configured with an encircling exterior bevel to enter the insertion end of a fluid conduit introduced into the coupling. The outer surface of the guide sleeve and the opposed interior surface of the bore define an annular gap configured to receive the wall of the insertion end of the conduit.

### RELATED APPLICATIONS

This application is a continuation-in-part application of U.S. Pat. No. 7,445,247 that issued on Nov. 4, 2008, from U.S. patent application Ser. No. 11/124,217 that was filed on May 6, 2005, and titled IRRIGATION COUPLING APPARATUS METHOD (hereinafter “the Parent Application”); the Parent Application is a continuation application of U.S. Pat. No. 7,021,672 that issued on Apr. 4, 2006, from U.S. patent application Ser. No. 10/678,013 that was filed on Oct. 2, 2003, and titled IRRIGATION COUPLING APPARATUS AND METHOD (hereinafter “the Grandparent Application”); and the Grandparent Application claims the benefit of U.S. Provisional Patent Application Ser. No. 60/474,040 that was filed on May 29, 2003, and titled IRRIGATION COUPLING APPARATUS AND METHOD.

### BACKGROUND OF THE INVENTION

1. Field of the Invention

The present invention relates to couplings for fluid systems. More specifically, the present invention relates to couplings that may be used to easily retain or release flexible plastic tubing such as that typically used in irrigation systems.

2. Background

Many types of systems have components between which fluid is conveyed through conduits. Such fluid systems include irrigation systems, household plumbing, air conditioning systems, heater humidifiers, misting systems, and garden hoses. Typically, the conduits of the fluid system must be coupled to components in such a manner that a fluid-tight seal is maintained. Thus, the process of connecting the conduits to their respective components can be somewhat time-consuming.

For example, in a standard residential irrigation system, lengths of polyvinylchloride (PVC) pipe are typically buried to act as conduits. The lengths of pipe must be attached to components of the system such as manifolds, electric valves, stop and waste valves, backflow prevention devices, sprinkler heads, and drip irrigation tubes. In some cases, other conduits such as conduit (i. e., “flexi-pipe”) may be used to couple a PVC pipe to an irrigation component.

More precisely, the lengths of PVC pipe or conduit must often be attached to each other or to irrigation components via application of primer and plastic cement. Such a process is somewhat time consuming and messy, and provides a relatively unreliable connection. To the extent that threaded or barbed fittings can be used, connection may be performed more rapidly than with primer and glue, but the integrity of the connection is still uncertain.

Furthermore, a glued connection cannot be released. Hence, if such a junction is faulty, the PVC pipe or flexi-pipe on either side of the junction must be severed, and one or more new junctions must be glued in place. Threaded fittings require that one of the parts be rotatable during attachment. Barbed fittings may be difficult for some people to install due to the force required to insert the barbs far enough to provide retention. Thus, connecting the components and lengths of PVC pipe and/or flexi-pipe together may be somewhat cumbersome and time-consuming.

Various types of couplings are available to attach irrigation components, PVC pipe, and/or flexible tubing together. However, known couplings have a number of inherent disadvantages. Often, such couplings require primer and glue, threaded attachment, or barbed attachment, and therefore add significantly to the required installation time. Some such couplings require tooling for attachment or detachment. Some couplings are not readily detachable, while others may not function properly under certain conditions, such as when buried underground.

Yet further, many known couplings do not indicate the proper size of conduit to make a fluid-tight connection with the coupling. Different manufacturers make irrigation flexi-pipe in sizes that are different enough to be incompatible, and yet similar enough to appear the same. Hence, many consumers may accidentally purchase or attempt to connect couplings and flexi-pipe that are incompatible with each other.

Still further, many known couplings designed to connect to flexi-pipe are rigid, and therefore require the flexi-pipe to be connected to the coupling at only one angle. Such an arrangement may tend to place undue stress on the flexi-pipe. The flexi-pipe may thus become weakened, disconnected, or pinched as a result.

### SUMMARY OF THE INVENTION

It is an overall objective of the present invention to provide fluid systems that include couplings that remedy the deficiencies of the prior art.

To achieve the foregoing objective, and in accordance with the invention as embodied and broadly described herein, a fluid system is provided. The fluid system may be an irrigation system, a heater humidification system, an air conditioning system, a misting system, an evaporative cooler, or the like. In one embodiment, the fluid system is an irrigation system designed to distribute water over soil. The irrigation system may include a plurality of components designed for soil irrigation, which may be termed “irrigation components.” Sprinkler heads, drip irrigation conduits, electrically operated valves, stop and waste valves, backflow preventers, conduits, garden hoses, and the like are irrigation components. Conduits convey irrigation water between the components. The conduits and components may be coupled together via couplings.

One exemplary subset of the irrigation system may have a conduit coupled to an irrigation component. The conduit may be a length of conduit, and may be formed of an inexpensive material such as plastic. The coupling is designed to connect an end of the conduit to a threaded end, or other fitting, of the irrigation component.

The coupling includes a coupling body and a release mechanism that is slidable with respect to the body to cause the body to release the conduit. The coupling body has a first end designed to be attached to the irrigation component and a second end into which is introduced the insertion end of the conduit. The first end may comprise a threaded end or the like. The second end may comprise a shoulder and two retention features that extend outward from the shoulder to interlock with the release mechanism.

The release mechanism may take the form of a release ring with an exterior sleeve that encircles the second end of the coupling body. The release ring has a pair of release grips that extend outward from the exterior sleeve. The release grips have contact surfaces oriented such that a user can easily press against them with digits of the hand to move the release ring. The release ring also has an interior sleeve coupled to the exterior sleeve by an annular wall disposed outside the second end. The interior and exterior sleeves cooperate to keep the release ring substantially coaxial with the first end of the coupling body.

The exterior sleeve is sized to provide a very small clearance with the shoulder. Hence, a narrow annular gap exists between the exterior sleeve and the shoulder. The clearance is small enough that dirt is generally unable to enter the annular gap, and is thus unable to impede the motion of the release ring. Hence, the coupling can be buried and subsequently disinterred without reducing the ability of a user to disconnect the conduit from the coupling using the release ring.

The coupling body has a bore that extends between the first end and the second end to convey water through the coupling. The insertion end of the conduit is introduced into the bore. The bore has a retention portion that is abutted by the insertion end of the conduit, when the insertion end has been advanced sufficiently into the bore.

According to another aspect of the present invention, a coupling for conveying fluid between a component of a fluid system and an insertion end of a conduit includes a conduit centering structure rigidly attached to the coupling body in axial alignment with the axis of the receiving end of the bore therein. In one inventive embodiment such a centering structure takes the form of a conduit guide that projects from the coupling body within the receiving end of the bore formed through the coupling body. The conduit guide is aligned with the axis of the receiving end of the bore. The conduit guide enters the insertion end of the fluid conduit as that end of the fluid conduit is introduced into the receiving end of the bore.

The conduit guide may be configured as a guide sleeve that is aligned with the axis of the receiving end of the bore and that has opposed first and second ends. The first end of the guide sleeve is secured to the coupling body interior of the bore, formed therethrough. The second end of the guide sleeve is configured for entry into the insertion end of the conduit by, for example, forming the exterior of the second end of the guide sleeve into an encircling bevel. The outer surface of the guide sleeve and the interior surface of the bore opposed thereto define an annular gap that configured to receive the wall of the insertion end of any fluid conduit introduced into the coupling.

A gripping mechanism, in the form of a spring washer, is seated against a lipped step in the bore in coaxial encirclement of the conduit guide. The spring washer has fingers that extend radially inward and are deflected when the end of the conduit is inserted into the bore. In response to force urging withdrawal of the end of the conduit from the bore, the fingers seat in the end of the conduit to provide gripping action, thereby keeping the end of the conduit from being withdrawn.

A seal ring is seated against a flat step of the bore, inward of the spring washer. The seal ring is formed of a resilient material such as rubber, such that the seal ring is able to form a substantially watertight seal against the outside diameter of the end of the conduit. The seal ring may have a countersink that facilitates insertion of the end of the conduit through the seal ring.

The coupling is easily installed by introducing the insertion end of the conduit into the bore until the insertion end of the conduit abuts the retention portion of the bore. The seal ring abuts the outside diameter of the end of the conduit to provide a seal, and the spring washer seats against the end of the coupling to keep the end within the bore. The irrigation component may be threadably engaged or otherwise attached to the first end of the coupling.

The coupling is also easily disconnected from the end of the conduit. The user may simply apply pressure against the release ring to slide the release ring along the axis of the bore. The interior sleeve presses against the fingers of the spring washer to push them away from the end of the conduit, thereby permitting withdrawal of the end of the conduit from the bore of the body.

Through the use of the apparatus and method of the invention, connections within fluid systems may be more easily and reliably made. Furthermore, the overall expense and installation time of such fluid systems may be reduced. These and other features and advantages of the present invention will become more fully apparent from the following description and appended claims, or may be learned by the practice of the invention as set forth hereinafter.

### BRIEF DESCRIPTION OF THE DRAWINGS

A particular description of the invention will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a side elevation view of a portion of a generalized fluid system having a component and a conduit interconnected by a first embodiment of a coupling incorporating teachings of the present invention;

FIG. 2 is an exploded perspective view of the fluid system of FIG. 1;

FIG. 3 is an enlarged cross-sectional elevation view of the coupling of FIGS. 1 and 2 in the engaged configuration thereof, wherein the coupling captures the end of any conduit inserted into the coupling;

FIG. 4 is a front elevation view of a spring washer disposed within the coupling of FIGS. 1-3

FIG. 5 is an enlarged cross-sectional elevation view of the coupling of FIGS. 1-3 in the disengaged configuration thereof, wherein the end of any conduit captured in the coupling is released therefrom;

FIG. 6 is an enlarged perspective view of a second embodiment of a coupling incorporating teachings of the present invention;

FIG. 7 is an enlarged cross-sectional elevation view of the coupling of FIG. 6 in the engaged configuration thereof, wherein the coupling captures the end of any conduit inserted into the coupling; and

FIG. 8 is an enlarged cross-sectional elevation view of the coupling of FIGS. 6-8 in the disengaged configuration thereof, wherein the end of any conduit captured in the coupling is released therefrom.

### DETAILED DESCRIPTION OF THE PREFERRED EMBODIMENTS

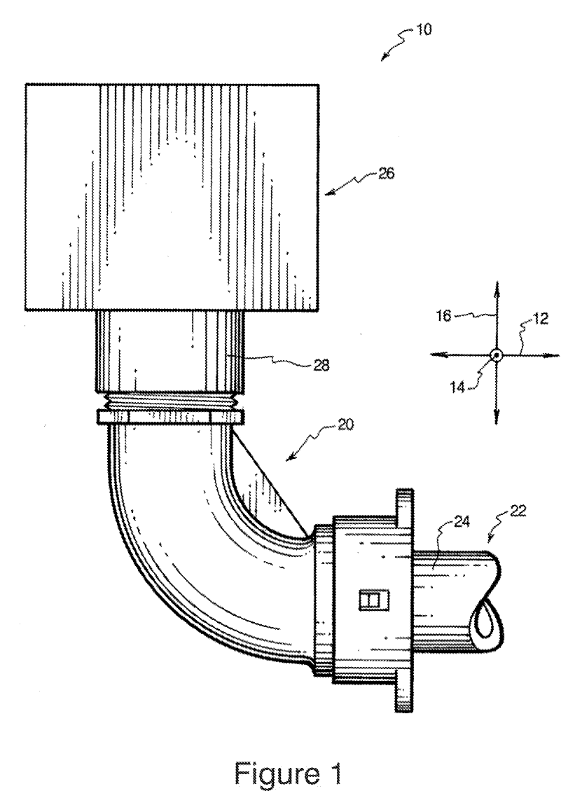

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 9, is not intended to limit the scope of the invention, as claimed, but is merely representative of presently preferred embodiments of the invention.

For this application, the phrases “connected to,” “coupled to,” and “in communication with” refer to any form of interaction between two or more entities, including mechanical, electrical, magnetic, electromagnetic, and thermal interaction. The phrase “attached to” refers to a form of mechanical coupling that restricts relative translation or rotation between the attached objects. The phrases “pivotally attached to” and “slidably attached to” refer to forms of mechanical coupling that permit relative rotation or relative translation, respectively, while restricting other relative motion.

The phrase “attached directly to” refers to a form of attachment by which the attached items are either in direct contact, or are only separated by a single fastener, adhesive, or other attachment mechanism. The term “abutting” refers to items that are in direct physical contact with each other, although the items may not be attached together. The terms “integrally formed” refer to a body that is manufactured integrally, i.e., as a single piece, without requiring the assembly of multiple pieces. Multiple parts may be integrally formed with each other if they are formed from a single workpiece.

Referring to FIG. 1, a side elevation view illustrates a portion of a generalized fluid system 10 according to one embodiment of the invention. A “fluid system” refers to any type of system that contains and/or moves fluid (including liquids, gases, and liquid/gas mixtures) through any type of conduit. The fluid system 10 may be of a wide variety of types, including but not limited to irrigation systems, heater humidification systems, air conditioning systems, evaporative cooling systems, misting systems for outdoor comfort, and the like. For convenience in this discussion, the fluid system 10 is assumed to be an irrigation system for distributing water onto soil.

The fluid system 10 has a longitudinal direction 12, a lateral direction 14, and a transverse direction 16. As shown, the fluid system 10 includes a coupling 20, which is designed to be attached to a length of conduit 22. The conduit 22 may include any of a variety of conduit types, including metal tubing, PVC pipe, or plastic “flexi-pipe” of a type commonly used in residential sprinkler systems. The conduit 22 has an end 24 designed to be captured by the coupling 20.

The coupling 20 provides fluid communication between the conduit 22 and a component 26, which may be any of a variety of fluid implements. “Fluid communication” refers to the existence of a generally enclosed fluid flow pathway between two articles. In the fluid system 10 of FIG. 1, the component 26 is designed for irrigation, and may thus include implements such as sprinkler heads, perforated water distribution tubes, electrically operated valves, stop and waste valves, backflow preventers, sprinkler risers, spray nozzles, garden hoses, and conduits. Since the invention includes a wide variety of fluid systems aside from irrigation systems, the term “component” contemplates the use of a wide variety of other types of fluid implements.

A “spray nozzle” may be any of a variety of nozzles such as hand sprayers for irrigation or household cleaning, misting nozzles designed to provide a comfortable mist in warm weather, internal furnace humidifier nozzles, and the like. A “perforated water distribution tube” may include drip irrigation lines, water distribution lines for evaporative coolers, and the like. A “valve” includes many different types of valves, including check valves, electrically operated valves, manually operated valves, and the like. A stop and waste valve for irrigation systems is included within the term “valve.”

In one embodiment, the component 26 is a sprinkler designed to be seated in the ground in a vertical orientation and fed by fluid flowing generally horizontally through the conduit 22. Thus, the coupling 20 is shaped to form a ninety-degree angle. The coupling 20 may thus be termed an “elbow fitting.” In other embodiments, similar couplings could be made straight, U-shaped, or with any other desirable angle. The component 26 has a fitting such as a threaded end 28 designed to engage the coupling 20. A “fitting” need not be a separate fastening device, but may simply be an attachment interface integrally formed with a component.

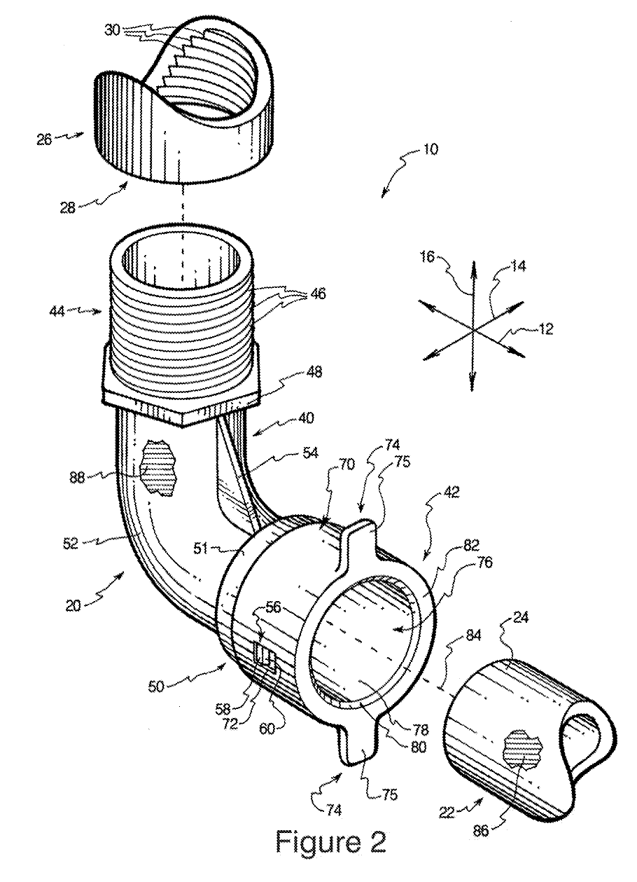

Referring to FIG. 2, an exploded, perspective view illustrates a portion of the fluid system 10 of FIG. 1 in greater detail. As shown, the threaded end 28 of the component 26 has been cut away to reveal that the threaded end 28 has threads disposed on an inside diameter thereof. The threads 30 thus act as female threads to attach the coupling 20 to the component 26. Of course, in an alternative embodiment, the component 26 could have male threads and the coupling 20 could have female threads.

In the embodiment shown, the coupling 20 has a body 40 and a release mechanism 42 that is slidable with respect to the body 40 along the longitudinal direction 12. “Slidable” refers to the ability for two objects to move relative to and in contact with each other. “Sliding” encompasses linear motion, rotary motion, and combinations thereof. In the embodiment shown, the release mechanism 42 is generally ring-shaped, and may thus be termed a release ring 42. The body 40 has a first end 44 designed to be connected to the threaded end 28 of the component 26. The first end 44 thus has threads 46 sized to mate with the threads 30 of the threaded end 28. Additionally, the first end 44 may have a hexagonal lip 48 that facilitates rotational coupling and tightening of the first end 44 with the threaded end 28 of the component 26.

In alternative embodiments, a wide variety of fitting types may be used in place of the threads 30 of the first end 44. For example, a female threaded fitting, quick-connect coupling, swage lock, snap-in fitting, or the like may be used to connect to a wide variety of corresponding fittings.

The body 40 also has a second end 50 in which a shoulder 51 is formed. The shoulder 51 is generally tubular in shape. The second end 50 and the first end 44 are separated by a bend 52 that provides the ninety-degree angle. The bend 52 is structurally supported by a gusset 54 that extends generally from the first end 44 to the second end 50.

The second end 50 has a pair of retention features 56 displaced from each other in the lateral direction 14, and thus positioned on opposite sides of the shoulder 51. The retention features 56 are designed to slidably retain the release ring 42. Each retention feature 56 has a plateau 58 that limits relative motion between the release ring 42 and the body 40, and a ramp 60 adjoining the plateau 58 to facilitate assembly of the release ring 42 and the body 40.

The release ring 42 has an exterior sleeve 70. The exterior sleeve 70 is sized just larger than the shoulder 51 so that the exterior sleeve 70 is able to act as a dirt shield, thereby preventing entry of dirt or other particles into the space between the release ring 42 and the second end 50. The exterior sleeve 70 extends a sufficient distance in the longitudinal direction 12 to provide a relatively snug fit between the release ring 42 and the second end 50 and enhance protection from contamination. The operation of the exterior sleeve 70 as a dirt shield will be discussed in greater detail subsequently. The dimensions of the exterior sleeve 70 also facilitate longitudinal motion of the release ring 42 with respect to the body 40 by maintaining the concentricity of the release ring 42 with the second end 50.

A pair of retention slots 72 is formed in the exterior sleeve 70 and positioned such that the retention features 56 extend into the retention slots 72. Each of the retention slots 72 is generally rectangular in shape, and is slightly longer in the longitudinal direction 12 than the combined longitudinal dimensions of the plateau 58 and the ramp 60 of the corresponding retention feature 56. Thus, the exterior sleeve 70 is able to move a limited distance in the longitudinal direction 12 with respect to the second end 50 of the body 40.

Disposition of the retention slots 72 and the retention features 56 on the outside of the coupling 20 is advantageous because they are relatively easy to manufacture and manipulate, and they do not interfere with insertion of the conduit 22 into the coupling 20. The retention slots 72 and the retention features 56 also operate in such a manner that no rotation of the release ring 42 is required to move between engaged and disengaged configurations. In alternative embodiments, a release mechanism may be rotatable or translatable and rotatable.

When the release ring 42 is extended from the second end 50, to the furthest extent permitted by the interlocking of the retention features 56 with the retention slots 72, the coupling 20 is in the engaged configuration, in which the end 24 of the conduit 22 may be retained within the coupling 20. When the release ring 42 is pressed toward the second end 50, the coupling 20 is in the disengaged configuration to permit removal of the end 24 from the coupling 20.

As shown, the release ring 42 also has a pair of release grips 74 extending in the transverse direction 16. The release grips 74 may be easily gripped and/or pressed in the longitudinal direction 12 to press the release ring 42 toward the second end 50 of the body 40. The release grips 74 facilitate movement of the release ring 42 in the longitudinal direction 12 by providing contact surfaces 75 that are generally perpendicular to the longitudinal direction 12. The contact surfaces 75 are easily and comfortably pressed by a user's fingers and/or thumb to exert the necessary pressure on the release ring 42. The release grips 74 may also facilitate one-handed actuation of the coupling 20 between the engaged and disengaged configurations.

The release ring 42 also has an interior sleeve 76 that defines a bore 78 into which the end 24 of the conduit 22 is inserted. A countersink 80 of the release ring 42 is disposed outside of and adjacent to the bore 78 to facilitate insertion of the end 24 into the bore 78. The release ring 42 has an annular wall 82 that extends from the interior sleeve 76 to the exterior sleeve 70. The shoulder 51 has an axis 84 extending along the longitudinal direction 12. The axis 84 is shared by the exterior sleeve 70, the interior sleeve 76, the annular wall 82, and a bore (not shown) of the body within the shoulder 51.

In alternative embodiments, the release ring 42 may simply be omitted. The corresponding coupling (not shown) may then be designed to permanently (i.e., non-releasably) retain the end of a conduit. Alternatively, such a coupling may release the end of the conduit in response to pressure from an external implement, such as a collar (not shown) slidable around the conduit. Such a collar may have two halves that are hinged or otherwise separable to permit removal of the collar from the conduit so that a single collar can be used to trigger release of a plurality of couplings.

Returning to the embodiment of FIG. 2, the conduit 22 has an indicator 86 disposed on its outside diameter. The indicator 86 indicates the size of the conduit 22, and may more particularly relate to the magnitude of the outside diameter of the conduit 22. Different manufacturers make flexible irrigation tubing in similar, and yet significantly different sizes. Consequently, a user may find it difficult to determine which irrigation implements are attachable to a given length of flexi-pipe. The indicator 86 is easily visible to the user to indicate the size of the conduit 22.

In this application, “indicating the size” does not necessarily require conveying the numerical size to a user; rather, only the category within which the size falls need be conveyed. Thus, the indicator 86 need not include letters or numbers, but may simply be a color. In the embodiment of FIG. 2, the indicator 86 is the color blue. The color blue may be useful because there is very little structure underground, whether natural or man-made, that is blue. The entire conduit 22 may have a blue color, which may be provided by injection molding the conduit 22 from blue plastic. Consequently, the indicator 86 may be easily visible, even when the conduit 22 is partially buried. Apart from use of the indicator 86 to indicate the size of the conduit 22, such a feature makes the conduit 22 easier to see and distinguish from other subterranean objects. Other colors besides blue may, of course, alternatively be used for the indicator 86.

The coupling 20, or more specifically, the body 40, may also have an indicator 88. The indicator 88 indicates the size of conduit receivable by the coupling 20 to provide a fluid-tight connection. The indicator 86 may thus correspond to the indicator 88 to show that the coupling 20 is compatible with the conduit 22. The indicator 86 may even be substantially the same as the indicator 88. Indicators that are “substantially the same” are indicators that would be visually recognized as pertaining to compatible or corresponding parts. If desired, the body 40 (and/or the remainder of the coupling 20) may be formed of blue plastic, and the conduit 22 may similarly be formed of plastic of the same blue color to indicate that they are connectable to each other. In alternative embodiments, the indicator 88 may be disposed on the release ring 42 in addition to or instead of on the body 40.

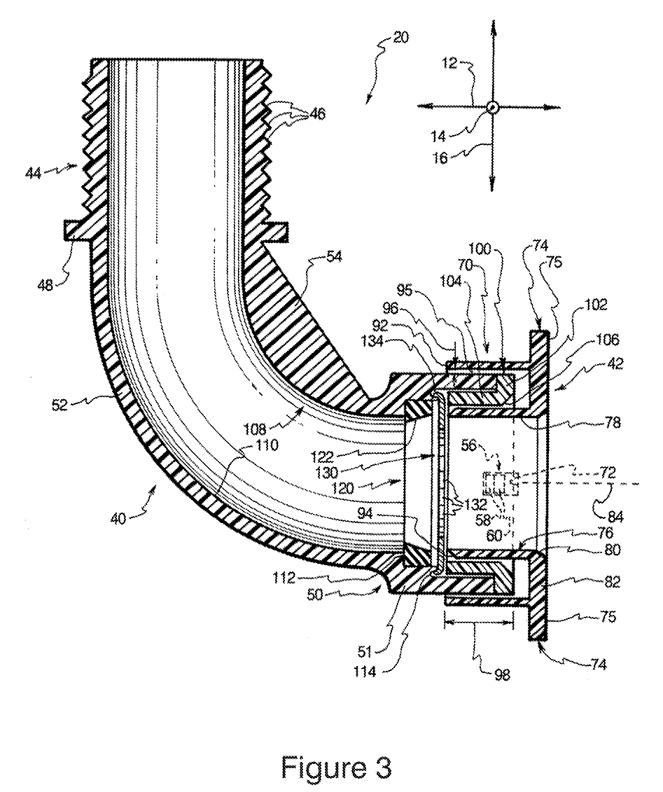

Referring to FIG. 3, a side elevation, section view illustrates the coupling 20, in isolation from the remainder of the fluid system 10. The coupling 20 is shown in the engaged configuration, as in FIGS. 1 and 2. Features of the interior of the coupling 20 will now be described, in connection with FIG. 3.

As shown, the exterior sleeve 70 of the release ring 42 has a countersink 92, which is oriented generally inward. The interior sleeve 76 also has a countersink 94, which is oriented generally outward. The countersinks 92, 94 are thus both oriented toward the corresponding surfaces of the shoulder 51 to facilitate assembly of the release ring 42 and the body 40.

An annular gap 95 exists between the exterior sleeve 70 and the shoulder 51. The annular gap 95 is dimensioned such that a clearance 96 exists between the exterior sleeve 70 and the shoulder 51. The clearance 96, when applied to both sides of the second end 50 (i.e., the top and bottom sides, with reference to the view of FIG. 3), results in the existence of an overall clearance of double the clearance 96. In order to prevent dirt entry into the annular gap 95, the clearance 96 may advantageously be less than about 0.02 inches. Furthermore, the clearance 96 may advantageously be less than about 0.01 inches, or even less than about 0.005 inches.

If desired, the clearance 96 may be the minimum clearance that still permits installation of the release ring 42 and the body 40. The clearance 96 may alternatively be the maximum clearance that generally keeps dirt from entering the annular gap 95 when the coupling 20 is buried. The tightness of the clearance 96 not only keeps dirt from the annular gap 95, but it also keeps dirt from entering the space inward of the annular wall 82. Thus, the clearance 96 helps to prevent dirt from increasing frictional resistance or direct physical interference with longitudinal motion of the release ring 42 toward the second end 50.

According to one embodiment, the diameter of the shoulder 51 and the inside diameter of the exterior sleeve 70 may have the same nominal value. When the release ring 42 and the body 40 are assembled, the exterior sleeve 70 may be stretched somewhat as the retention features 56 wedge apart opposite sides of the exterior sleeve 70 to slide into the retention slots 72 of the exterior sleeve 70. Thus, the inside diameter of the exterior sleeve 70 may enlarge somewhat to provide the clearance 96. The clearance 96 is then sufficient to permit the release ring 42 to slide with respect to the second end 50, but small enough to restrict dirt entry into the annular gap 95.

The clearance 96 extends for a length 98 of the second end 50 sufficient to avoid dirt entry, and more particularly, to keep dirt from passing through the annular gap 95 to interfere with sliding motion of the release ring 42. The length 98 may advantageously be over one-quarter inch. In alternative embodiments, the length 98 may be as small as one-eighth of an inch or three-sixteenths of an inch, or as great as one-half inch or three-eighths of an inch. The length 98 shown is when the release ring 42 is positioned to retain the end 24 of the conduit 22, which is the position in which the release ring 42 is normally disposed.

The coupling 20 has a retainer ring 100 in addition to the body 40 and the release ring 42. The retainer ring 100 has a lip 102 that extends outward (i.e., in the lateral and transverse directions 14, 16) adjacent to the edge of the shoulder 51. The retainer ring 100 also has a sleeve 104 extending generally within the second end 50. A countersink 106 is disposed at the juncture of the sleeve 104 with the lip 102 to facilitate assembly of the release ring 42 with the retainer ring 100.

As shown, the body 40 has a bore 108 that extends from the first end 44 to the second end 50. The bore 108 curves along with the bend 52 and, as it passes through the second end 50, shares the axis 84. The bore 108 has a retention portion 110 sized to receive the end 24 of the conduit 22. The retention portion 110 may be sized to press inward against the end 24 in such a manner that the retention portion 110 grips the end 24 to keep the conduit 22 in place. The bore 108 also has a flat step 112 at which the diameter of the bore 108 steps up from that of the retention portion 110. Furthermore, the bore 108 has a lipped step 114 at which the diameter of the bore 108 steps up from that of the region between the flat step 112 and the lipped step 114.

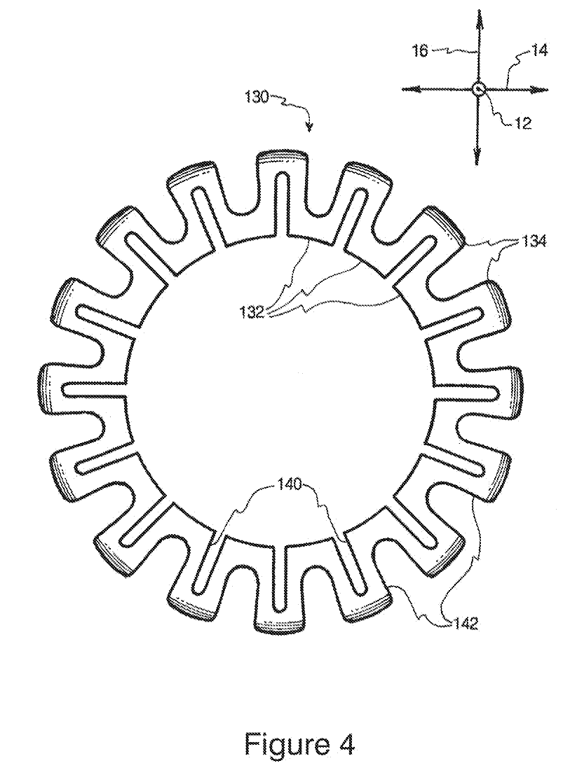

A seal ring 120 is seated against the flat step 112. The seal ring 120 is formed of a resilient material such as rubber. The seal ring 120 has a generally annular shape, with a countersink 122 facing inward and toward the release ring 42. A spring washer 130 is seated against the lipped step 114. The spring washer 130 has a plurality of fingers 132 that extend inward. The spring washer 130 also has a peripheral lip 134 that curls over the lipped step 114 so that the peripheral lip 134 is unable to contract excessively during deflection of the spring washer 130. The configuration of the spring washer 130 will be shown and described with greater clarity in connection with FIG. 4.

The coupling 20 may be fabricated in a variety of ways. According to one method, the body 40, the release ring 42, and the retainer ring 100 are all formed of plastic via injection molding. Blow molding, stamping, or other methods may alternatively be used. The seal ring 120 may be injection molded of an elastomer such as rubber, and the spring washer 130 may be stamped of a metal such as steel, stainless steel, or aluminum.

The seal ring 120 may first be inserted into the bore 108 of the body 40 along the longitudinal direction 12 and seated against the flat step 112 of the bore 108. The spring washer 130 may then be inserted into the bore 108 along the longitudinal direction 12 and seated against the lipped step 114 in such a manner that the peripheral lip 134 of the spring washer 130 engages the lipped step 114.

After the seal ring 120 and the spring washer 130 have been installed, the retainer ring 100 may be inserted into the bore 108 of the body 108 along the longitudinal direction 12 in such a manner that the sleeve 104 of the retainer ring 100 rests directly within the second end 50, as shown in FIG. 3. The sleeve 104 may then abut or be disposed directly adjacent to the peripheral lip 134 of the spring washer 130 so that the retainer ring 100 keeps the spring washer 130 in place. The spring washer 130, in turn, keeps the seal ring 120 in place.

When the retainer ring 100 has been disposed in the position illustrated in FIG. 3, the retainer ring 100 may be ultrasonically welded, thermally welded, adhesive bonded, or otherwise attached to the second end 50. If desired, an annular bead (not shown) may be formed on the lip 102 of the retainer ring 100 at a position such that the annular bead is sandwiched between the lip 102 and the second end 50 when the retainer ring 100 is installed. The annular bead may then fuse with the second end 50 during ultrasonic welding to secure the lip 102 to the second end 50.

When the retainer ring 100 has been secured, the release ring 42 may be inserted into engagement with the second end 50 along the longitudinal direction 12. The release ring 42 is inserted such that the interior sleeve 76 passes through the countersink 106 and into the sleeve 104 of the retainer ring 100. The countersinks 106, 94 cooperate to facilitate insertion and centering of the interior sleeve 76 of the release ring 42 within the sleeve 104 of the retainer ring 100. Simultaneously, the exterior sleeve 70 of the release ring 42 passes around the lip 102 of the retainer ring 100 and around a portion the shoulder 51, as shown in FIG. 3. The countersink 92 of the exterior sleeve 70 aids insertion and centering of the exterior sleeve 70 around the lip 102 and the second end 50.

As the sleeves 70, 76 engage the retainer ring 100 and the second end 50, the exterior sleeve 70 expands in the lateral direction 14 to pass around the retention feature 56, as described previously. The ramps 60 are positioned such that the release ring 42 is able to be inserted longitudinally over the second end 50 so that the ramps 60 cause the exterior sleeve 70 to expand in the lateral direction 14, thereby permitting continued motion of the release ring 42 in the longitudinal direction 12. The exterior sleeve 70 extends around the retention features 56 until the retention features 56 are captured within the retention slots 72 of the exterior sleeve 70. If desired, the exterior sleeve 70 may have interior grooves (not shown) extending from the retention slots 72 to the countersink 92 to facilitate passage of the exterior sleeve 70 over the retention features 56.

Once the retention slots 72 have moved far enough to capture the retention features 56, the coupling 20 is fully assembled and ready for use. The spring washer 130 exerts pressure on the countersink 94 of the interior sleeve 76 of the release ring 42 to urge the release ring 42 to remain positioned as in FIG. 3, so that the coupling 20 remains in the engaged configuration. The engagement of the retention features 56 with the retention slots 72 keeps the release ring 42 from moving further from the body 40 and the retainer ring 100.

The end 24 of the conduit 22 may be easily engaged within the coupling 20. More precisely, the end 24 may be inserted into the bore 78 of the interior sleeve 76 along the longitudinal direction 12. The end 24 may be pushed deeper into the coupling 20 so that the end 24 passes through the spring washer 130, thereby causing the fingers 132 of the spring washer 130 to deflect outward (i.e., in the lateral and transverse directions 14, 16), and toward the retention portion 110 of the bore 108 of the body 40. The end 24 then passes through the seal ring 120 and may optionally be pushed into the retention portion 110 until the outer wall of the end 24 abuts the retention portion 110.

Alignment of the end 24 with the seal ring 120 during insertion is facilitated by the countersink 122 of the seal ring 120. The seal ring 120 presses against the end 24 to form a substantially fluid-tight seal (i.e., a watertight seal in the context of an irrigation system). The seal keeps fluid from leaking out of the coupling 20 through the second end 50 at pressure differentials up to the maximum operating pressure of the fluid system 10. Accordingly, fluid loss can be avoided without complicating the process of attaching the end 24 to the coupling 20.

When the end 24 is disposed within the retention portion 110, the spring washer 130 is deflected in such a manner that, if the conduit 22 is drawn longitudinally outward, the fingers 132 seat themselves in the conduit 22 to prevent withdrawal of the end 24 from the coupling 20. Hence, the end 24 cannot be withdrawn from within the coupling 20 without moving the coupling 20 to the disengaged configuration, which will be shown and described subsequently, in connection with FIG. 4.

Referring to FIG. 4, a front elevation view illustrates the spring washer 130 in isolation, in substantially undeflected form. As shown, the fingers 132 extend inward from the peripheral lip 134. The peripheral lip 134 extends in the longitudinal direction 12, i.e., toward the retention portion 110 of the bore 108 of the body 40 (shown in FIG. 3). In this application, “finger” does not denote any specific shape or length-to-width ratio. Rather, a “finger” is simply an extension. In alternative embodiments, a spring washer may have fewer fingers, each of which extends around a substantial portion of the diameter of the end 24. For example, only two fingers, each of which has a near-semicircular profile, may be disposed on either side of such a spring washer to retain the end 24.

Returning to the embodiment of FIG. 4, the spring washer 130 has a plurality of interior slots 140 that separate the fingers 132 from each other. The interior slots 140 are arrayed in generally radial fashion. The spring washer 130 also has a plurality of exterior slots 142 that facilitate flexing of the fingers 132 in the longitudinal direction 12 and enable the peripheral lip 134 to maintain its size and engagement with the lipped step 114 during flexing of the fingers 132.

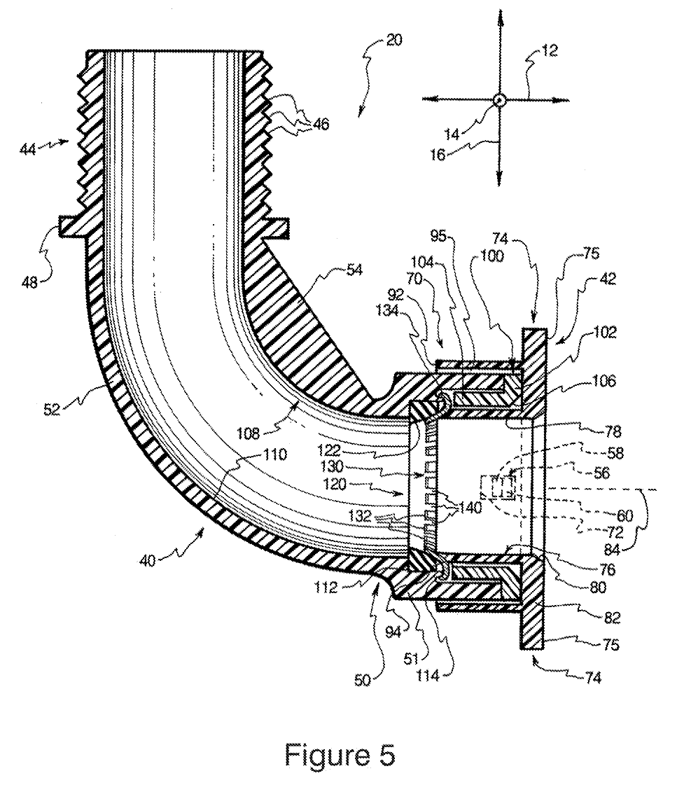

Referring to FIG. 5, a side elevation, section view illustrates the coupling 20 in the disengaged configuration. The release ring 42 is simply actuated longitudinally toward the retainer ring 100 by, for example, holding the body 40 and pressing the release grips 74 of the release ring 42 toward the body 40. The interior sleeve 76 of the release ring 42 moves further into the bore 108 and the countersink 94 of the interior sleeve 76 presses against the spring washer 130.

The release ring 42 may move longitudinally until the annular wall 82 of the release ring 42 abuts the lip 102 of the retainer ring 100. At this point, the retention slots 72 have moved such that the retention features 56 are disposed at the opposite end of the retention slots 72 from their position in the engaged configuration.

In response to pressure from the countersink 94 of the interior sleeve 76, the fingers 132 deflect toward the retention portion 110 of the bore 108, as illustrated in FIG. 5. The fingers 132 simultaneously bend outward to define a diameter larger than the outside diameter of the conduit 22. Thus, the fingers 132 no longer seat in the conduit 22, and the end 24 of the conduit 22 can be freely withdrawn along the longitudinal direction 12 from the bore 108.

The release ring 42 may then be released to permit the coupling 20 to return to the disengaged configuration. Then, the conduit 22 or a different conduit may then be coupled or re-coupled via insertion into the bore 108, as described previously.

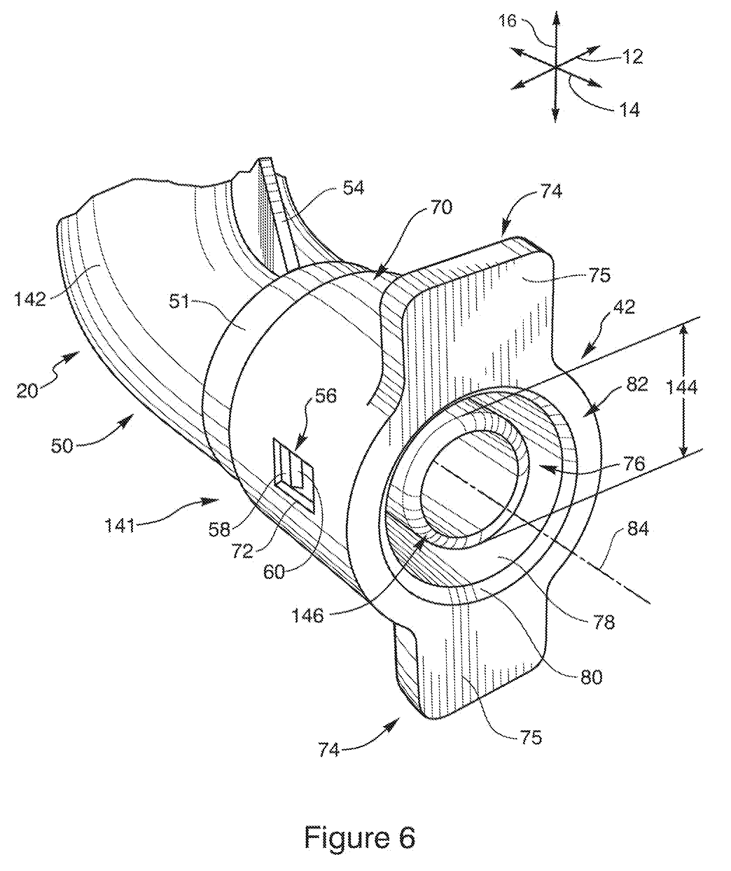

FIG. 6 is an enlarged perspective view of a second embodiment of a coupling 141 incorporating teachings of the present invention. In FIG. 6, structures identical to those previously presented in FIGS. 1-5 will, without renewed introduction, be identified with the same reference characters as were used in descriptions previously presented relative to those figures.

Coupling 141 includes a coupling body 142 and release mechanism 42 that is slidable with respect to coupling body 142 along longitudinal direction 12. Release mechanism 42, being generally ring-shaped, will also be identified herein, but with additional specificity, as release ring 42. Release ring 42 includes exterior sleeve 70 and interior sleeve 76. Interior sleeve 76 defines an open-ended bore, or passageway 78, into which an insertion end of a fluid conduit, such as conduit 22, is introduced in order to become coupled to a fluid system that includes coupling 141. Extending between interior sleeve 76 and exterior sleeve 70 beyond coupling body 142, release ring 42 includes annular wall 82. As positioned on coupling body 142, interior sleeve 76, annular wall 82, and exterior sleeve 70 are each substantially circularly-symmetric about axis 84 of shoulder 51.

Visible through the open end of passageway 78 presented in FIG. 6 is a conduit centering structure 144 that is rigidly attached, in a manner not apparent from FIG. 6 alone, to the interior of coupling body 142. Conduit centering structure 144 is axial aligned with axis 84 of shoulder 51. Centering structure 144 takes the particular form in coupling 141 of a conduit guide 146 that projects toward the open end of bore 108 through coupling body 142. Centering structure 144 is intended to enter the insertion end of any fluid conduit introduced into coupling 141, thereby to guide the insertion end of the conduit in an optimally-centered manner toward a secure and fluid-tight seating within coupling 141.

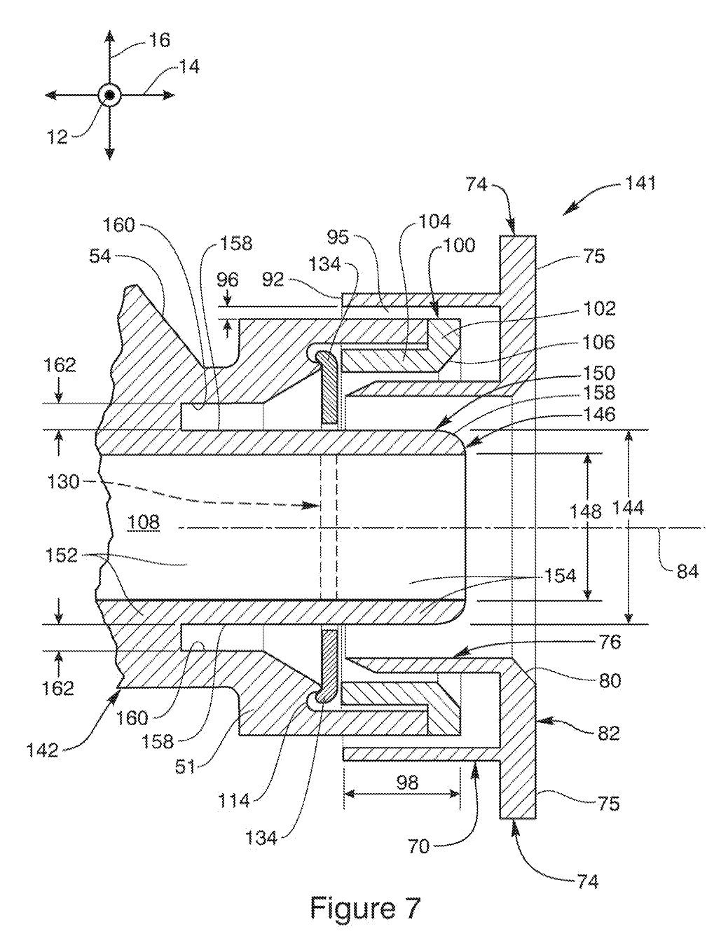

FIG. 7 is an enlarged cross-sectional elevation view of coupling 141 in the engaged configuration thereof, wherein coupling 141 captures the end of any conduit introduced thereinto. To do so, spring washer 130 is seated against lipped step 144 on the inside of coupling body 142 in coaxial encirclement of centering structure 144. Spring washer 130 includes a plurality of fingers 132 that project radially inwardly from peripheral lip 134 and are separated from each other by a corresponding plurality of interior slots 140. Fingers 132 of spring washer 130 flex radially outwardly to accommodate the advancement of the insertion end of a fluid conduit through spring washer 130, but fingers 132 resile radially inwardly into a seating engagement with the outer surface of the fluid conduit, doing so at an orientation that resists the withdrawal of the insertion end of the conduit from coupling 141.

A fluid flow lumen 148 extends through conduit guide 146. It is fluid flow lumen 148 that actually effects fluid communication between the insertion end of a fluid conduit introduced into coupling 141 and bore 108 within coupling body 142. The presence of fluid flow lumen 148 causes conduit guide 146 to be capable of characterization as a guide sleeve 150. Guide sleeve 150 has a first end 152 and a free second end 154 opposite therefrom. First end 152 of guide sleeve 150 is secured to coupling body 142 interior of bore 108. Second end 154 of guide sleeve 150 is configured for entry into the insertion end of a fluid flow conduit by, for example, forming the outer surface 156 of guide sleeve 150 at second end 154 of guide sleeve 150 into an encircling bevel 158. Outer surface 156 of guide sleeve 150 and an interior surface 160 of bore 108 opposed thereto define an annular gap 162 that is so configured to receive the wall of the insertion end of any fluid conduit seated in coupling 141.

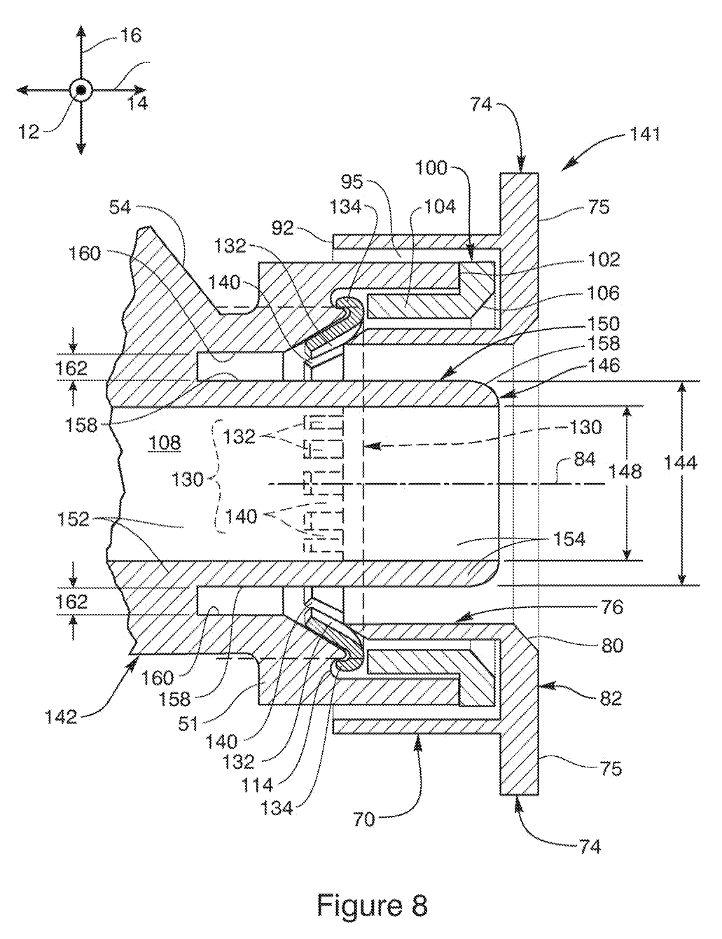

The structures of centering structure 144 reappear in FIG. 8, which is an enlarged cross-sectional elevation view of coupling 141 in the disengaged configuration thereof, wherein the insertion end of any fluid conduit captured in coupling 141 is released therefrom.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A coupling for conveying fluid between a component of a fluid system and an insertion end of a conduit, the outer surface of the insertion end of the conduit being smooth and free of groves, flanges, and beads, said coupling comprising:
a coupling body having a bore formed therethrough, the insertion end of the conduit being introduced into a receiving end of said bore;
a conduit centering structure rigidly attached to said coupling body in axial alignment with the axis of said receiving end of said bore;
a gripping mechanism capable of fixing the position of the insertion end of the conduit in said receiving end of said bore; and
a release mechanism slidable relative to said coupling body into a disengaging position wherein said release mechanism induces said gripping mechanism to release the insertion end of the conduit.

2. A coupling as recited in claim 1, wherein said conduit centering structure comprises a conduit guide projecting from said coupling body within said receiving end of said bore, said conduit guide entering the insertion end of the conduit as the insertion end of the conduit is introduced into said receiving end of said bore.

3. A coupling as recited in claim 2, wherein said conduit guide is aligned with the axis of said receiving end of said bore.

4. A coupling as recited in claim 2, wherein a fluid flow lumen extends through said conduit guide, and said lumen effects fluid communication between said insertion end of the conduit and said bore interior of said coupling body.

5. A coupling as recited in claim 1, wherein said gripping mechanism comprises a spring washer seated in said receiving end of said bore in coaxial encirclement of said conduit centering structure.

6. A coupling as recited in claim 5, wherein said spring washer comprises a plurality of radially inwardly extending fingers, said fingers of said spring washer flexing radially outwardly to accommodate advancement of said insertion end of the conduit through said spring washer, and said fingers resiling radially inwardly into seating engagement with the outer surface of said conduit at an orientation resisting withdrawal of the insertion end of the conduit from said receiving end of said bore.

7. A coupling as recited in claim 6, wherein said release mechanism comprises an interior sleeve extending into said receiving end of said bore, in said disengaging position of said release mechanism said interior sleeve inducing radially outward flexure of said fingers out of said seating engagement with the outer surface of said conduit.

8. A coupling as recited in claim 7, wherein said release mechanism further comprises an outer sleeve sized to encircle said coupling body at said receiving end of said bore with a clearance sufficiently small to restrict interference by dirt to motion of said release mechanism into an out of said disengaging position.

9. A coupling for conveying fluid between a component of a fluid system and an insertion end of a conduit, the outer surface of the insertion end of the conduit being smooth and free of groves, flanges, and beads, said coupling comprising:
a coupling body having a bore formed therethrough, the insertion end of the conduit being introduced into a receiving end of said bore;
a conduit guide projecting from said coupling body within said receiving end of said bore in axial alignment therewith, said conduit guide as the insertion end of the conduit is introduced into said receiving end of said bore the insertion end of the conduit;
a spring washer seated in said receiving end of said bore in coaxial encirclement of said conduit guide; and
a release mechanism slidable relative to said coupling body into a disengaging position wherein said release mechanism induces said gripping mechanism to release the insertion end of the conduit.

10. A coupling as recited in claim 9, wherein said conduit guide comprises a guide sleeve having opposed first and second ends, said first end of said guide sleeve being secured to said coupling body interior of said bore, and said second end of said guide sleeve being configured for entry into the insertion end of the conduit.

11. A coupling as recited in claim 10, wherein said spring washer comprises a plurality of radially inwardly extending fingers, said fingers of said spring washer flexing radially outwardly to accommodate advancement of said insertion end of the conduit through said spring washer, and said fingers of said spring washer resiling radially inwardly into seating engagement with the outer surface of said conduit at an orientation resisting withdrawal of the insertion end of the conduit from said receiving end of said bore.

12. A coupling as recited in claim 11, wherein said release mechanism comprises an interior sleeve extending into said receiving end of said bore, in said disengaging position of said release mechanism said interior sleeve inducing radially outward flexure of said fingers out of said seating engagement with the outer surface of said conduit.

13. A coupling as recited in claim 12, wherein said release mechanism further comprises:
an outer sleeve sized to encircle said coupling body at said receiving end of said bore with a clearance sufficiently small to restrict interference by dirt to motion of said release mechanism into an out of said disengaging position; and
an annular wall extending between said interior sleeve and said exterior sleeve beyond said receiving end of said bore, the interior of said annular wall abutting said coupling body at said receiving end of said bore to limit motion of said release mechanism into said disengaging position.

14. A coupling as recited in claim 13, wherein said release mechanism further comprises diametrically opposed release grips extending radially outwardly from said annular wall in the plane thereof.

15. A coupling as recited in claim 13, further comprising cooperating structures formed, respectively, on said outer sleeve of said release mechanism, and on said coupling body, said cooperating structures interacting to secure said release mechanism to said coupling body and to establish a limited range of motion of said release mechanism relative to said coupling body.

16. A coupling for conveying fluid between a component of a fluid system and an insertion end of a conduit, the outer surface of the insertion end of the conduit being smooth and free of groves, flanges, and beads, said coupling comprising:
a coupling body having a bore formed therethrough, the insertion end of the conduit being introduced into a receiving end of said bore;
guide sleeve having opposed first and second ends, said first end of said guide sleeve being secured to said coupling body interior of said bore in axial alignment with said receiving end of said bore, and said second end of said guide sleeve being configured for entry into the insertion end of the conduit;
a gripping mechanism capable of fixing the position of the insertion end of the conduit in said receiving end of said bore; and
a release mechanism slidable relative to said coupling body into a disengaging position wherein said release mechanism induces said gripping mechanism to release the insertion end of the conduit.

17. A coupling as recited in claim 16, wherein the outer surface of said guide sleeve and the interior surface of bore opposed thereto define an annular gap configured to receive the wall of the insertion end of the conduit.

18. A coupling as recited in claim 17, wherein said gripping mechanism comprises a spring washer seated in said receiving end of said bore in coaxial encirclement of said conduit centering structure, said spring washer comprising a plurality of radially inwardly extending fingers, said fingers of said spring washer flexing radially outwardly to accommodate advancement of said insertion end of a conduit through said spring washer, and said fingers resiling radially inwardly into seating engagement with the outer surface of said conduit at an orientation resisting withdrawal of the insertion end of the conduit from said receiving end of said bore.

19. A coupling as recited in claim 18, wherein said release mechanism comprises an interior sleeve extending into said receiving end of said bore, in said disengaging position of said release mechanism said interior sleeve inducing radially outward flexure of said fingers out of said seating engagement with the outer surface of said conduit.

20. A coupling as recited in claim 19, wherein the exterior of the free end of said interior sleeve is beveled.
